(19) United States
(12) Patent Application Publication
(10) Pub. No.: US 2026/0213233 A1
(43) Pub. Date: Jul. 23, 2026

(54) METHOD FOR DETECTING A MALFUNCTION, TANK SYSTEM, COMPUTER PROGRAM PRODUCT AND STORAGE MEANS

(71) Applicant: Robert Bosch GmbH, Stuttgart (DE)

(72) Inventors: Markus Strasser, Stuttgart (DE); Birgit Lenz, Korntal (DE); Christian Kuhnert, Vaihingen/Enz (DE); Christian Schugger, Stuttgart (DE); Martin Schwab, Sindelfingen (DE); Nicolas Wussler, Esslingen Am Neckar (DE); Stefan Kieferle, Stuttgart (DE)

(21) Appl. No.: 19/137,899

(22) PCT Filed: Jan. 3, 2023
(86) PCT No.: PCT/EP2023/050063

§ 371 Date: Jun. 11, 2025

(30) Foreign Application Priority Data
Sep. 15, 2022 (DE) 10 2022 209 692.4
Sep. 15, 2022 (DE) 10 2022 209 693.2
Sep. 15, 2022 (DE) 10 2022 209 697.5

(51) Int. Cl. H01M 8/04664; G01M 99/00; H01M 8/04302; H01M 8/0438; H01M 8/04746

(52) U.S. Cl. CPC H01M 8/04664; G01M 99/008; H01M 8/04302; H01M 8/04388; H01M 8/04753

(57) ABSTRACT

The present invention relates to a method for detecting a malfunction of a fuel outlet arrangement (16) in a tank system (11) for a fuel cell system (10), comprising the steps of: performing a startup operation of the fuel cell system (10) and thereby conducting fuel from fuel tanks (12, 13, 14) through a fuel line arrangement (15), determining a refilling value concerning a refilling of fuel via the fuel line arrangement (15) into at least one fuel tank (12, 13, 14) during the startup operation, providing a reference refilling value, performing a comparison between the determined refilling value during the startup operation and the provided reference refilling value, and detecting a malfunction of the fuel outlet arrangement (16) based on the comparison. The invention also relates to a tank system (11) and a computer program product (23) for carrying out the method, as well as a computer-readable storage medium (24) on which such a computer program product (23) is stored.

### BACKGROUND

The present invention relates to a method for detecting a malfunction in a gas system, in particular in a tank system of a fuel cell system. The invention also relates to a tank system in which or with which such a method can be carried out, a corresponding computer program product, and a computer-readable storage medium on which such a computer program product is stored.

Fuel cell systems usually have complex tank systems. DE 10 2017 212 485 A1, for example, describes a system for storing fuel in a tank system for a vehicle, wherein the tank system comprises tubular tank containers and a high-pressure fuel distributor with integrated control and safety technology. The tank containers are made of metal and are connected to the high-pressure fuel distributor with integrated control and safety technology in a modular fashion to form a module with a flexible geometry.

### SUMMARY

During operation, the tank containers should be protected as well as possible against mechanical and/or thermal stresses such as vibrations, braking, or acceleration. This also applies to the protection of the tank containers in the event of an accident. Furthermore, it is desirable to monitor the tank system at all times in order to detect any malfunctions in the tank system as early as possible. This always poses a challenge when using multiple tank containers.

The present invention proposes solutions for improving known methods and systems for detecting a malfunction in a tank system of a fuel cell system. In particular, a method according to the disclosure, a tank system according to the disclosure, a computer program product according to the disclosure and a computer-readable storage medium according to the disclosure are proposed. Further embodiments of the invention arise from the dependent claims, the description, and the figures. Features that are described in connection with the method also apply in connection with the tank system according to the invention, the computer program product according to the invention, the storage medium according to the invention and vice versa, so that reference is and/or can always be made reciprocally to the individual aspects of the invention with regard to the disclosure.

According to a first aspect of the present invention, a method for detecting a malfunction of a fuel outlet arrangement in a tank system, in particular for a fuel cell system or an alternative gas system, is proposed, wherein the tank system comprises a plurality of fuel tanks, a fuel line arrangement for conducting fuel from the fuel tanks, and a fuel outlet arrangement with an outlet means for each fuel tank for the controlled conducting of fuel from the fuel tanks into the fuel line arrangement. The method has the following steps:
performing a startup operation, in particular of the fuel cell system or the alternative gas system, and thereby conducting fuel from the fuel tanks through the fuel line arrangement,
determining a refilling value concerning a refilling fuel via the fuel line arrangement into at least one fuel tank during the startup operation,
providing a reference refilling value,
performing a comparison between the refilling value determined during startup operation and the reference refilling value provided, and
detecting a malfunction of the fuel outlet arrangement based on the comparison.

Within the scope of the present invention, it has been discovered that meaningful conclusions regarding a possible malfunction of the fuel outlet arrangement can be drawn relatively easily on the basis of the refilling value during startup operation. In particular, it was recognized that a specific malfunction can be detected on the basis of an unusually high refill during a subsequent start or subsequent operation without refueling the fuel tanks in the meantime.

If all outlet valves of the outlet means on the fuel tanks comply with the permissible pressure drop, a brief pressure increase will occur when switching to a reduced fuel mass flow or consumer mass flow. This means that an increased valve throttle effect on an individual fuel tank leads to a higher tank pressure in this fuel tank compared to the other fuel tanks during a tank empty run with a high fuel mass flow or during increased operation with an increased or higher fuel mass flow. The one faulty fuel tank is running behind, so to speak. If the tank system is subsequently operated with a sufficiently small or with the predefined and/or predefinable reduced fuel mass flow, this can lead to refilling from one fuel tank to the other tanks. If such refilling is detected, a corresponding malfunction can be detected.

As part of the method, predefined measures can also be initiated based on the detected and/or displayed malfunction. This means that if the malfunction or at least one malfunction is detected, at least one predefined measure can be initiated. The measure can be understood to mean the output of a visual and/or acoustic warning signal. The warning signal can be audibly and/or visually perceptible to a user of the tank system and/or the fuel cell system, for example in the form of a driver of a vehicle with the fuel cell system.

The malfunction can be detected and then displayed. The display of the malfunction can be understood to mean the output of a warning signal as described above. Furthermore, displaying the malfunction can be understood to mean generating a warning signal that is stored in a memory from which it can be read out by a specialist, for example during an inspection of the tank system. The read-out warning signal can be used to draw conclusions about a malfunction that may have occurred or is still present. Measures can then be taken to prevent the malfunction, at least in the future.

The outlet means can have outlet valves which, in a method according to the invention, can all be electrically actuated simultaneously or essentially simultaneously. In particular, the outlet valves can be controlled in parallel for starting or during startup operation of the fuel cell system. The electrical actuation can be understood to mean that the outlet valves, if possible, are actuated to a release state for conducting the fuel from the respective fuel tank into the fuel line arrangement. The outlet valves can be understood as tank valves that are installed directly or essentially directly on the fuel tanks. A suitable extraction filter can be positioned at each outlet valve. The outlet valve and extraction filter preferably form the essential and/or sole component of the respective outlet means. The fuel tanks are preferably hydrogen tanks. Detecting and possibly displaying a malfunction of the fuel outlet arrangement based on the comparison can be understood to mean that the at least one malfunction can be detected and displayed using the comparison or a comparison result. This means that the comparison result can be evaluated accordingly to detect and display the malfunction and/or taken into account in a suitable calculation. The method can be carried out in particular to detect a malfunction of a fuel outlet arrangement in a fuel cell system of a vehicle, in particular during operation of the fuel cell system in the vehicle. The method can basically be carried out using any gas system. Accordingly, the term “fuel” can generally be understood as a fluid or gas.

The method steps according to the invention do not have to be carried out in the specified order. Individual method steps can also be carried out in a different sequence and/or simultaneously. For example, it is possible that the reference refilling value is first provided and/or calculated and only then is the actual refilling value determined.

If, for example, the comparison reveals that the determined refilling value is greater than the reference refilling value by a predefined value, this may indicate a malfunction, in particular a clogged extraction filter. This means that the malfunction can be detected, for example, if it is recognized that the determined refilling value is greater than a predefined maximum permissible refilling value. As part of the comparison, for example, a difference between the reference refilling value and the determined refilling value can be calculated. The corresponding difference between the refilling values can be compared with a predefined threshold value and/or a reference difference. If the difference is greater than the predefined threshold value or the reference difference, a malfunction as described above can be concluded.

In a method according to the invention, it is also possible that during the startup operation, a pressure buildup gradient is determined in the fuel line arrangement and the refilling value is determined based on the pressure buildup gradient. The pressure buildup gradient is a simple and reliable way of determining the refilling value. Accordingly, an unusually high refilling can be determined by an excessive pressure increase in the fuel line arrangement after commissioning the tank system or fuel cell system. The pressure buildup gradient is preferably determined in a high-pressure line section of the fuel line arrangement. The pressure buildup gradient is preferably determined by pressure measurements and a pressure evaluation of a line pressure in the fuel line arrangement over time. The pressure buildup gradient can therefore be determined using suitable measurement sensors and a computing unit that is connected to the measurement sensors. The measuring sensor system can have at least one pressure sensor for determining the pressure buildup gradient. The determined pressure buildup gradient can be compared with a provided and/or calculated target pressure buildup gradient, wherein the refilling value can be determined based on the comparison between the determined pressure buildup gradient and the provided target pressure buildup gradient. The comparison according to the invention between the determined pressure buildup gradient and the provided target pressure buildup gradient is carried out in particular when no pressure buildup is measured in a medium-pressure line section of the fuel line arrangement in which the gas pressure is at least on average lower than in the high-pressure line section, or no pressure build-up can be detected by measurement. In this way, the tightness of a pressure controller in the fuel line arrangement can be checked to ensure that the mass flow through the respective outlet valve was only effective for the pressure build-up in the high-pressure line section. The provision of the target pressure buildup gradient can be understood to mean that the target pressure buildup gradient is read from a memory and thereby made available for comparison, or is first calculated and only then made available for comparison. This means that the provision may also include determining and/or calculating the target pressure buildup gradient and then providing it.

According to a further embodiment of the present invention, it is possible that the following steps are carried out in a method:
determining a tank pressure in the respective fuel tank during startup operation,
determining a line pressure in the fuel line arrangement,
performing comparisons between the tank pressure in the respective fuel tank and the line pressure, and
determining the refilling value based on the comparisons performed.

In this way, the refilling and consequently the malfunction can be determined particularly reliably and/or the actual presence of a malfunction can be checked easily. If the pressure buildup gradient determined or the comparison with the target pressure buildup gradient described above indicates a malfunction, such as a clogged extraction filter, this can now be checked and specified. In particular, it is possible to determine which tank contains the potentially clogged extraction filter. However, such a determination and/or associated calculations only need to be carried out if there is reason to do so based on the detection of a possible malfunction as described above. In other words, if no indication of a malfunction is found based on the initial comparison, subsequent calculations to determine a more accurate cause of the error may be omitted. This allows the process to be carried out with low computing capacity and thus in an energy-efficient manner.

The following additional or alternative steps are possible for a further check
determining a tank pressure in the respective fuel tank during startup operation,
performing comparisons between the respective determined tank pressures in the fuel tanks, and
determining the refilling value based on the comparisons performed.

The following additional or alternative steps are also possible:
determining a fuel level in the respective fuel tank during startup operation,
performing comparisons between the respective determined fuel level in the fuel tanks, and
determining the refilling value based on the comparisons performed.

This is another particularly reliable way of determining or checking and specifying the malfunction.

In a method according to the invention, it is also possible for the outlet means to each have an extraction filter and for the malfunction to be detected with reference to a degree of clogging of an extraction filter of at least one outlet means. This means that, based on the comparison according to the invention or by means of the comparison according to the invention, a malfunction can be detected in particular in that a clogged extraction filter of an outlet means is detected. Accordingly, the malfunction can be understood as a degree of clogging of an extraction filter of at least one outlet means which is above a reference degree of clogging or a predefined and/or predefinable maximum permissible degree of clogging. If an excessive degree of fouling is detected, appropriate countermeasures can be initiated to address any problems that may arise. In particular, operation of the fuel cell system or the tank system can be prevented if a fuel tank cannot or would not be emptied as desired or would not be available as desired for supplying fuel.

Another aspect of the present invention relates to a tank system for a fuel cell system, comprising a plurality of fuel tanks, a fuel line arrangement for conducting fuel from the fuel tanks, and a fuel outlet arrangement with an outlet means for each fuel tank for controlled conducting of fuel from the fuel tanks through the fuel line arrangement. The tank system further comprises a control unit for performing a startup operation of the fuel cell system or an alternative gas system and thereby conducting fuel from the fuel tanks through the fuel line arrangement, a determination unit for determining a refilling value concerning a refilling of fuel via the fuel line arrangement into at least one fuel tank during startup operation, and a computing unit for performing a comparison between the determined refilling value during the startup operation and a reference refilling value provided, and for detecting a malfunction of the fuel outlet arrangement based on the comparison. The tank system according to the invention thus has the same advantages as those described in detail with reference to the method according to the invention. The target pressure buildup gradient described above can be calculated by means of a computing unit and/or read out from a memory in order to perform the comparison with the determined pressure buildup gradient. The computing unit may be configured and designed to calculate the target pressure buildup gradient in the manner described above. The tank system can be configured and designed as part of a fuel cell system. The fuel cell system can be configured and designed as part of a vehicle.

The invention also proposes a tank system that is configured and designed to carry out the method described above. This means that the tank system can have suitable sensors, a suitable computing unit, and/or suitable actuators for carrying out the method.

A further aspect of the invention relates to a computer program product comprising commands which cause the method steps according to the invention to be carried out in a tank system as described above. The invention also relates to a computer-readable, in particular non-volatile, storage medium on which such a computer program product is stored. The computer program product according to the invention and the storage medium thus also have the advantages described above.

The computer program product can be implemented as computer-readable instruction code in any suitable programming language and/or machine language such as JAVA, C++, C# and/or Python. The computer program product may be stored on a computer-readable storage medium such as a data disc, removable drive, volatile or non-volatile memory, or a built-in memory/processor. The instruction code can program a computer or other programmable device, such as a control device of the fuel cell system and/or a vehicle with the fuel cell system, to perform the desired functions. Furthermore, the computer program product may be and/or can be provided on a network, such as the Internet, from which it can be downloaded by a user on demand. The computer program product can be realized by means of software as well as by means of one or more special electronic circuits, i.e. in hardware or in any hybrid form, i.e. by means of software components and hardware components.

### BRIEF DESCRIPTION OF THE DRAWINGS

Further measures that improve the invention are shown in the following description of various exemplary embodiments of the invention, which are shown schematically in the figures. All features and/or advantages resulting from the claims, the description, or the figures, including design details and spatial arrangements, can be essential to the invention both individually and in the various combinations.

It shows schematically in each case:

FIG. 1 a fuel cell system with a tank system according to one embodiment of the present invention,

FIG. 2 a tank system according to one embodiment of the present invention,

FIG. 3 storage means with a computer program product stored thereon according to an embodiment of the present invention, and

FIG. 4 a flowchart explaining a method according to one embodiment of the present invention.

### DETAILED DESCRIPTION

Elements having the same function and mode of action are in each case provided with the same reference signs in the figures.

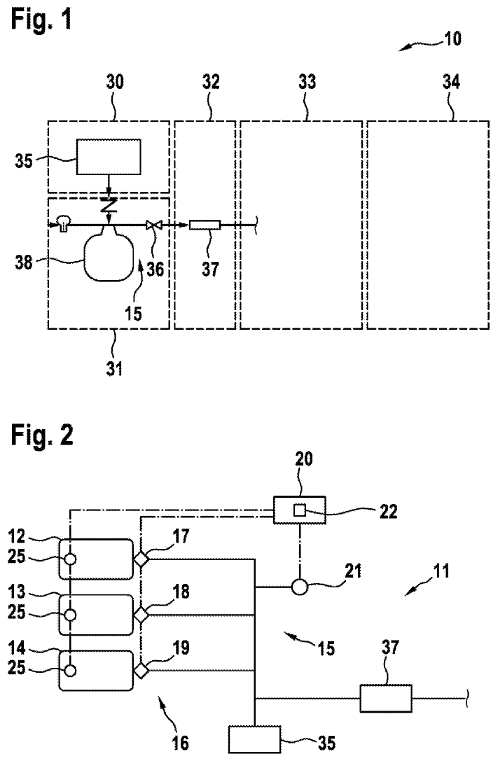

FIG. 1 shows a fuel cell system 10 that is configured and designed for mobile use in a vehicle. The fuel cell system 10 has a filling section 30 with a tank connection 35 in the form of a connection nozzle. The fuel cell system 10 further comprises a storage section 31 with a fuel line arrangement 15, a fuel tank arrangement 38 and a valve 36 in the form of a shut-off or shut-off valve. In addition, the fuel cell system 10 has a supply section 32 with a pressure controller 37, through which the fuel can be fed in a controlled manner from the storage section 31 into a fuel cell section 33 of the fuel cell system 10. In addition, the fuel cell system 10 has a power section 34 in which the current or voltage generated in the fuel cell section 10 can be converted into drive power for the vehicle.

FIG. 2 shows a tank system 11 for a fuel cell system 10 as shown in FIG. 1. The tank system 11 shown in FIG. 2 has three fuel tanks 12, 13, 14, a fuel line arrangement 15 for conducting fuel from the fuel tanks 12, 13, 14 and a fuel outlet arrangement 16 for controlled conducting of fuel from the fuel tanks 12, 13, 14 through the fuel line arrangement 15. The fuel tanks 12, 13, 14 are connected to the fuel line arrangement 15 in parallel. The fuel outlet arrangement 16 has three outlet means 17, 18, 19, wherein one outlet means 17, 18, 19 is installed on each fuel tank 12, 13, 14. Each outlet means 17, 18, 19 has an outlet valve and an extraction filter (not shown in detail). Furthermore, a pressure sensor 25 is provided in each tank for determining a gas pressure in the respective fuel tank 12, 13, 14. The tank system 11 also has a control unit 20 for carrying out a startup operation of the fuel cell system 10 and, in doing so, for directing fuel from the fuel tanks 12, 13, 14 through or into the fuel line arrangement 15. The control unit 20 is shown schematically and can have several components mutually spaced. The control unit 20 can have a control device, in particular in the form of a central vehicle control device.

In addition, the tank system 11 has a determination unit 21 for determining a refilling value concerning a refilling of fuel via the fuel line arrangement 15 into at least one fuel tank 12, 13, 14 during startup operation. For this purpose, the determination unit 21 has a further pressure sensor for determining a line pressure and, in particular, for determining a pressure buildup gradient in the fuel line arrangement 15 during startup operation in a predefined time after electrical actuation of the outlet means.

According to the embodiment shown in FIG. 2, a component of the control unit 20 is a computing unit 22 for carrying out a comparison between the determined refilling value during startup operation and a provided reference refilling value and for detecting a malfunction of the fuel outlet arrangement 16 based on the comparison. The computing unit 22 may further be configured to perform a comparison between the determined pressure buildup gradient during startup operation and the provided target pressure buildup gradient to determine the refilling value.

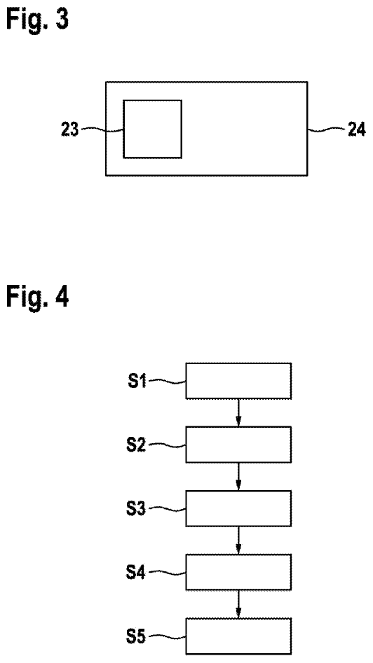

FIG. 3 shows a computer-readable, non-volatile storage medium 24 in the form of a memory stick. A computer program product 23 is stored on the storage medium 24. The computer program product 23 comprises commands that cause the tank system 11 shown in FIG. 1 and FIG. 2 to execute a method, which is subsequently explained with reference to FIG. 4.

With reference to the flowchart shown in FIG. 4, a method for detecting a malfunction of the fuel outlet arrangement 16 described above is explained. More precisely, the method can be used to find out whether or not the fuel outlet arrangement 16 has a malfunction, in particular in the form of at least one clogged extraction filter. For this purpose, a startup operation of the fuel cell system 10 is carried out in a step S1, whereby fuel is fed from the fuel tanks 12, 13, 14 through or into the fuel line arrangement 15. In a second step S2, a refilling value is determined concerning a refilling of fuel via the fuel line arrangement 15 into at least one fuel tank 12, 13, 14 during startup operation. For this purpose, a pressure buildup gradient is determined in the fuel line arrangement 15 by means of the determination device 21 during startup operation, whereby the refilling value or a corresponding refilling level is determined on the basis of the determined pressure buildup gradient. In a third step S3, which does not necessarily have to be carried out after the second step S2, a reference refilling value is provided. In a fourth step S4, a comparison is made between the refilling value determined during startup operation and the reference refilling value provided. In a fifth step S5, a malfunction of the fuel outlet arrangement 16 is carried out based on the comparison and concretized or represented as a corresponding error signal. In other words, the comparison is used to determine whether or not there is a malfunction in the fuel outlet arrangement 16, in particular in the form of at least one clogged extraction filter.

The invention allows for further design principles in addition to the illustrated embodiments. That is to say, the invention is not intended to be limited to the exemplary embodiments explained with reference to the figures. In particular, the pressure sensors 25 in the respective fuel tanks 12, 13, 14 could be dispensed with. If the pressure sensors 25 are present, the following steps can be carried out to detect the malfunction: determining a tank pressure in the respective fuel tank 12, 13, 14 during the startup operation, determining a line pressure in the fuel line arrangement 15, performing comparisons between the tank pressure in the respective fuel tank 12, 13, 14 and the line pressure, and determining the refilling value based on the comparisons performed. Alternatively or additionally, it is possible to carry out the following steps: determining a tank pressure in the respective fuel tank during the startup operation, performing comparisons between the respective tank pressures determined in the fuel tanks, and determining the refilling value based on the comparisons performed. In addition, the following steps could be carried out alternatively or additionally: determining a fuel level in the respective fuel tank during the startup operation, performing comparisons between the respective fuel levels determined in the fuel tanks, and determining the refilling value based on the comparisons performed.

1. A method for detecting a malfunction of a fuel outlet arrangement (16) in a tank system (11), wherein the tank system (11) has several fuel tanks (12, 13, 14), a fuel line arrangement (15) for conducting fuel from the fuel tanks (12, 13, 14) and a fuel outlet arrangement (16) with an outlet means (17, 18, 19) for each fuel tank (12, 13, 14) for the controlled conducting of fuel from the fuel tanks (12, 13, 14) through the fuel line arrangement (15),
the method comprising:
performing a startup operation and thereby conducting fuel from the fuel tanks (12, 13, 14) through the fuel line arrangement (15),
determining a refilling value concerning a refilling fuel via the fuel line arrangement (15) into at least one fuel tank (12, 13, 14) during the startup operation,
providing a reference refilling value,
performing a comparison between the refilling value determined during startup operation and the reference refilling value provided, and
detecting a malfunction of the fuel outlet arrangement (16) based on the comparison.

2. The method according to claim 1,
wherein
during the startup operation, a pressure buildup gradient is determined in the fuel line arrangement (15) and the refilling value is determined based on the pressure buildup gradient.

3. The method according to claim 1,
wherein:
determining a tank pressure in the respective fuel tank (12, 13, 14) during startup operation,
determining a line pressure in the fuel line arrangement (15),
performing comparisons between the tank pressure in the respective fuel tank (12, 13, 14) and the line pressure, and
determining the refilling value based on the comparisons performed.

4. The method according to claim 1,
wherein
determining a tank pressure in the respective fuel tank (12, 13, 14) during startup operation,
performing comparisons between the respective determined tank pressures in the fuel tanks (12, 13, 14), and
determining the refilling value based on the comparisons performed.

5. The method according to claim 1,
wherein
determining a fuel level in the respective fuel tank (12, 13, 14) during startup operation,
performing comparisons between the respective determined fuel level in the fuel tanks (12, 13, 14), and
determining the refilling value based on the comparisons performed.

6. The method according to claim 1,
wherein
the outlet means (17, 18, 19) each have an extraction filter and the malfunction is detected with reference to a degree of clogging of an extraction filter of at least one outlet means (17, 18, 19).

7. A tank system (11) for a fuel cell system (10), comprising:
a plurality of fuel tanks (12, 13, 14),
a fuel line arrangement (15) for conducting fuel from the fuel tanks (12, 13, 14),
a fuel outlet arrangement (16) with an outlet means (17, 18, 19) for each fuel tank (12, 13, 14) for the controlled conducting of fuel from the fuel tanks (12, 13, 14) through the fuel line arrangement (15),
a control unit (20) configured to perform a startup operation of the fuel cell system (10) and thereby cause fuel to be conducted from the fuel tanks (12, 13, 14) through the fuel line arrangement (15),
a determination unit (21) configured to determine a refilling value concerning a refilling fuel via the fuel line arrangement (15) into at least one fuel tank (12, 13, 14) during the startup operation, and
a computing unit (22) configured to perform a comparison between the determined refilling value during startup operation and a reference refilling value provided, and to determine a malfunction of the fuel outlet arrangement (16) based on the comparison.

8. The tank system (11) according to claim 7, which is configured to perform a method according to claim 1.

9. (canceled)

10. A non-transitory, computer-readable storage medium (24) containing instructions that when executed by a computer cause the computer to detect a malfunction of a fuel outlet arrangement (16) in a tank system (11), wherein the tank system (11) has several fuel tanks (12, 13, 14), a fuel line arrangement (15) for conducting fuel from the fuel tanks (12, 13, 14) and a fuel outlet arrangement (16) with an outlet means (17, 18, 19) for each fuel tank (12, 13, 14) for the controlled conducting of fuel from the fuel tanks (12, 13, 14) through the fuel line arrangement (15), by:
performing a startup operation and thereby causing fuel from the fuel tanks (12, 13, 14) to be conducted through the fuel line arrangement (15),
determining a refilling value concerning a refilling fuel via the fuel line arrangement (15) into at least one fuel tank (12, 13, 14) during the startup operation,
providing a reference refilling value,
performing a comparison between the refilling value determined during startup operation and the reference refilling value provided, and
detecting a malfunction of the fuel outlet arrangement (16) based on the comparison.
